(19) United States
(12) Patent Application Publication
(10) Pub. No.: US 2024/0233351 A1
(43) Pub. Date: Jul. 11, 2024

(54) METHOD AND APPARATUS FOR COMPUTER VISION BASED ON NEURAL EXPOSURE FUSION FOR HIGH-DYNAMIC RANGE OBJECT DETECTION

(71) Applicant: Torc Robotics, Inc., Blacksburg, VA (US)

(72) Inventors: Emmanuel Luc Julien Onzon, Munich (DE); Felix Heide, Palo Alto, CA (US); Maximilian Rufus Bömer, Munich (DE); Fahim Mannan, Montreal (CA)

(21) Appl. No.: 18/545,874

(22) Filed: Dec. 19, 2023

Related U.S. Application Data
(60) Provisional application No. 63/436,551, filed on Dec. 31, 2022.

(51) Int. Cl. G06V 10/80; G06T 5/70; G06V 10/60; G06V 10/82

(52) U.S. Cl. CPC G06V 10/806; G06T 5/70; G06V 10/60; G06V 10/82

(57) ABSTRACT

Departing from conventional HIDR image fusion approach, a learned task-driven fusion in the feature domain is disclosed. Instead of using a single companded image, the disclosed method exploits semantic features from all exposures learned in an end-to-end fashion with supervision from downstream detection losses. The method outperforms all tested conventional HDR exposure fusion and auto-exposure methods in challenging automotive HIDR scenarios.

### CROSS-REFERENCE TO RELATED APPLICATIONS

This application claims priority to U.S. Provisional Patent Application No. 63/436,551 titled Method and Apparatus for Computer Vision Based on Neural Exposure Fusion for High-Dynamic Range Object Detection, filed Dec. 31, 2022, the entire contents of which are hereby incorporated herein by reference.

### TECHNICAL FIELD

The field of the disclosure relates generally to computer vision and, more specifically, to object detection within images of scenes of high dynamic range of illumination.

### BACKGROUND OF THE INVENTION

Computer vision pipelines operating in unconstrained outdoor scenarios must tackle challenging high dynamic range (HDR) scenes and rapidly changing illumination conditions. Existing methods address this problem with multi-capture HDR sensors and a hardware image signal processor (ISP) that produce a single fused image as input to a downstream neural network. The output of the HDR sensor is a set of low dynamic range (LDR) exposures, and the fusion in the ISP is performed in image space and typically optimized for human perception on a display. Preferring tone-mapped content with smooth transition regions over detail (and noise) in the resulting image, this image fusion does not necessarily preserve all information from the LDR exposures that may be essential for downstream computer vision tasks.

A wide range of computer vision tasks require predictions in outdoor scenarios at real-time rates, with applications range from self-driving vehicles and advanced driver assistance systems to drones and robots in farming and outdoor maintenance. The global dynamic range of luminance of real-world scenes is 280 dB. Within this range, a typical outdoor scene covers a sub-range of about 120 dB, and such a typical scene already exceeds what conventional CMOS image sensors can capture at around 60-70 dB. Additionally, in-the-wild computer vision systems, routinely have to handle more challenging conditions, such as facing the sun in presence of large, shadow-casting objects (backlights) or moving from indoor to outdoor and back (e.g., entrance and exit of a tunnel). In such cases, the range of luminance seen at the same time can reach 180 dB, and they exceed the range of today's robotic and automotive high dynamic range (HDR) image sensors (covering around 120-140 dB). Moreover, existing computer vision systems must also be able to adapt to changing illumination conditions in real-time, for example when the vision system, or large objects in the environment, move quickly.

There is a need, therefore, to explore methods for reliable object detection in unconstrained outdoor scenarios.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed system departs from the conventional approach of capturing a bracketed HDR raw capture, fusion and detection. Instead of image space HDR fusion, a feature-domain fusion approach is adopted. Feature-domain fusion is driven by a downstream detection task, without the need to reconstruct a single HDR image. Specifically, feature maps from the different exposures are fused into a single feature map. A novel attention module is used to help the neural network determine, at each spatial location, the exposure that contains the most relevant information concerning the object detection task. A “local cross-attention fusion” attends to features locally across exposures. The queries of this cross-attention module are learned, while the keys and the values are the feature vectors at each location, across the different exposures. In contrast to the standard query-key-value attention module, in the local cross-attention fusion, the softmax is normalized across both dimensions of its output.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1(a) illustrates an HDR camera with modern HDR image sensors capable of producing a stack of LDR images taken at different exposures in a short time frame. This feature enables performing fusion at a later stage in the pipeline.

FIG. 1(b) illustrates challenging scenarios for conventional HDR systems: Tunnel entrance and exit, oncoming traffic or strong backlight. Scenes with large luminance range complicate HDR fusion in image space and result in poor detail and low contrast.

FIG. 2(a) illustrates conventional HDR exposure fusion performed in image space, before object detection.

FIG. 2(b) illustrates an alternative approach to HDR object detection, where multi-exposure captures are not merged on the sensor but fused in the feature domain, in accordance with an embodiment of the present disclosure.

FIG. 3 illustrates “Local Cross-Attention Fusion” where cross attention with learned query matrix Q is applied locally to n-feature maps stacked into y, at row r and column c, resulting in the weight vector α_{.r.c}, which is used to produce the vector at location (r, c) of the fused feature map ƒ_{fm}, in accordance with an embodiment of the present disclosure, the softmax is normalized with respect to both axes.

FIG. 4 illustrates qualitative comparison of the Local Cross-Attention Fusion with the baseline methods HDR II and Deep HDR for challenging scenes. The neural fusion module recovers features from separate exposure streams, where the image region is well exposed to make its decision. In contrast, the fused HDR image may miss details and local contrast resulting in false negatives and false positives.

FIG. 5 illustrates a qualitative comparison of the proposed Local Cross-Attention Fusion with the baseline methods HDR II and Deep HDR on challenging scenes. Examples from the additional dataset of entrances and exits of tunnels, see supplemental text.

FIG. 6 illustrates a qualitative comparison of the proposed Local Cross-Attention Fusion with the baseline methods HDR II and Deep HDR on challenging scenes. Our neural fusion module recovers features from separate exposure streams, where the image region is well exposed to make its decision. Examples from the night and sun illumination conditions subset.

Corresponding reference characters indicate corresponding parts throughout the several views of the drawings. Although specific features of various examples may be shown in some drawings and not in others, this is for convenience only. Any feature of any drawing may be reference or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Loss function: The loss functions used herein are variants of known loss functions (covering “Fast RCNN” and “Faster RCNN”. The variants aim at enhancing predictions. The variables to be adjusted to minimize the loss are:
1. The weights and biases of the neural networks that form the computer-vision pipeline (auto-exposure, feature extractor, object detectors); and
2. The trainable parameters of the ISP (denoiser strength, filters' parameters, etc.).

Learning is ascertained upon finding values of the variables that minimize the loss on a selected number of training examples.

Processor: The term refers to a hardware processing unit, or an assembly of hardware processing unit.

Module: A module is a set of software instructions, held in a memory device, causing a respective processor to perform a respective function.

Device: The term refers to any hardware entity

Field of view: The term refers to a “view” or “scene” that a specific camera can capture

Dynamic range: The term refers to luminance contrast, typically expressed as a ratio (or a logarithm of the ratio) of the intensity of the brightest point to the intensity of the darkest point in a scene.

High dynamic range (HDR): A dynamic range exceeding the capability of current image sensors.

Low dynamic range (LDR): A portion of a dynamic range within the capability of an image sensor. A number of staggered LDR images of an HDR scene may be captured and combined (fused) to form a respective HDR image of the HDR scene.

Standard dynamic range (SDR): A selected value of an illumination dynamic range, within the capability of available sensors, may be used consistently to form images of varying HDR values.

The terms SDR and LDR are often used interchangeably; the former is more commonly used.

The term “companding” refers to compression of the bit depth of the HDR linear image applying a piecewise affine function after which the resulting image is no longer a linear image. An inverse operation that produces a linear image is referenced as “decompanding”. (See details on pages 22-24 of AR0231 “Image Sensor Developer Guide”.)

Exposure bracketing: Rather than capturing a single image of a scene, several images are captured, with different exposure settings, and used to generate a high-quality image that incorporates useful content from each image.

Exposure-specific images: The term refers to time-multiplexed raw images corresponding to different exposures.

Dynamic-range compression: Several techniques for compressing the illumination dynamic range while retaining important visual information are known in the art

Computer-vision companding: The term refers to converting an HDR image to an LDR image to be expanded back to high dynamic range.

Image signal processing (ISP): The term refers to conventional processes (described in EXHIBIT-III) to transform a raw image acquired from a camera to a processed image to enable object detection. An “ISP processor” is a hardware processor performing such processes, and an “ISP module” is a set of processor-executable instructions causing a hardware processor to perform such processes.

Differentiable ISP: The term “differentiable ISP” refers to a continuous function of each of its independent variables where the gradient with respect to the independent variables can be determined. The gradient is applied to a stochastic gradient descend optimization process.

Exposure-specific ISP: The term refers to processing individual raw images of multiple exposures independently to produce multiple processed images.

Object: The shapes of objects are not explicitly predefined. Instead, they are implicitly defined from the data. The possible shapes are learned. The ability of the detector to detect objects with shapes unseen in the training data depends on the amount and variety of training data and also critically on the generalization ability of the neural network (this depends on its architecture, among other things). In the context of 2D-object detection, and for the neural network that performs the detection, objects are defined by two things: 1. the class it belongs to (e.g., a car), 2. its bounding box, i.e., the smallest rectangle that contains the object in the image (e.g., x-coordinate of the left and right sides and y-coordinate of the top and bottom sides of the rectangle). These are the outputs of the detector. The loss is computed by comparing them with the ground truth (i.e., the values specified by the human annotators for the given training examples). With this process, the neural network implicitly learns to recognize objects based on the information in the data (including its shape, color, texture, surroundings, etc.).

Exposure-specific detected-objects: The term refers to objects from a same scene that are identified in each processed exposure-specific image.

Feature: In the field of machine learning, the term “feature” refers to significant information extracted from data. Multiple features may be combined to be further processed. Thus, extracting a feature from data is a form of data reduction.

Thus, a feature is an information extracted from the image data that is useful to the object detector and facilitates its operation. A feature has a higher information content than the simple pixel values of the image about the presence or absence of objects at their location in the image. For example, a feature could encode the likelihood of the presence of a part of an object. A map of features (i.e., several features at several locations in the image) is computed thanks to a feature extractor that has been trained on a different vision task on a large number of examples. This feature extractor is further trained (i.e., fine-tuned) on the task at hand.

In the field of deep neural network, the use of the term “feature” derives from its use in machine learning in the context of shallow models. When using shallow machine learning models (such as linear regression or logistic regression), “feature engineering” is used routinely in order to get the best results. This comprises computing features from the data with especially hand-crafted algorithms before applying the learning model to these features instead of applying the learning model directly to the data (i.e., feature engineering is a pre-processing step that happens before training the model takes place). For computer vision such features could be edges or textures, detected by hand-crafted filters. The advent of deep neural networks in computer vision has enabled learning such features automatically and implicitly from the data instead of doing feature engineering. As such, in the context of deep neural networks, a feature is essentially an intermediate result inside the neural network, that bears meaningful information that can be further process to better solve the problem at hand or even to solve other problems. Typically, in the field of computer vision, a neural network that has been trained for image classification with millions of images and for many classes is reused as a feature extractor within a detector. The feature extractor is then fine-tuned by further learning from the training examples of the object detection data set. For instance, a variant of the neural network ResNet as a feature extractor is used herein. Experimentation is performed with several layers within ResNet (Conv1, Conv2, etc.) to be used as a feature map. For object detection, a feature map could encode the presence of elements that make up the kind of objects to be detected. For example, in the context of automotive object detection, where it is desired to detect cars and pedestrians, the feature map could encode the presence of elements such as human body parts and parts of cars such as wheels, headlights, glass texture, metal texture, etc. These are examples of features that the feature extractor might learn after fine tuning. The features facilitate the operation of the detector compared with using directly the pixel values of the image.

Exposure-specific features: The term refers to features extracted from an exposure-specific image

Fusing: Generally speaking, fusing is an operation that takes as input several entities containing different relevant information for the problem at hand and outputs a single entity that has a higher information content. It can be further detailed depending on the type of entity as described below:
1. Fusion of images: For images, fusion means producing a single image that contains all of the information (or as much information) contained in any of the input images. In HDR imaging, image fusion means producing an HDR image that covers the overall dynamic range encompassed by the set of SDR images used as input.
2. Fusion of feature maps: Each input feature map is a 4-dimensional tensor of the same shape (n, h, w, c), where n is the number of training (or evaluation) examples in a mini-batch, h is the height, w is the width and c is the number of “channels” (i.e., number of features at a given location and for a given example). The output of the feature fusion is a feature map that is again a 4-dimensional tensor of the same shape (n, h, w, c). The purpose of the feature fusion is to produce an output feature map containing a combination of the information contained in any of the input feature maps and has a higher information content, more amenable to further useful processing.
3. Fusion of sets of detected objects: Sets of detected objects are fused with the following method. First the union of the sets is done. Then a subset of the detected objects is removed from the set of detected objects using non maximal suppression (NMS). Pruning of the set of detected objects using NMS is a standard procedure which use is widespread in computer vision.

Pooling: In the context of object detection, the word “pooling” is mostly used in phrases such as “average pooling”, “maximum pooling” and “region-of-interest (ROI) pooling”. They are used to describe parts of a neural network architecture. These are operations within neural networks. ROI pooling is an operation that is widely used in the field of object detection.

Maximum pooling operation: In the context of “early fusion”, the phrase “maximum pooling” (or “element-wise maximum”) simply means element-wise maximum across several tensors. In the wider context of neural network architecture, it also means computing the maximum spatially in a small neighborhood.

Exposure Fusion: The dynamic range of a scene may be much greater than what current sensors cover, and therefore a single exposure may be insufficient for proper object detection. Exposure fusion of multiple exposures of relatively low dynamic range enables capturing a relatively high range of illuminations. Disclosed are fusion strategies at different stages of feature extraction without the need to reconstruct a single HDR image.

Auto Exposure Control: Commercial auto-exposure control systems run in real-time on either the sensor or the ISP hardware. The methods of the present disclosure rely on multiple exposures, from which features are extracted to perform object detection.

Single-exposure versus multi-exposure camera: A single-exposure camera typically applies image dependent metering strategies to capture the largest dynamic range possible, while a multi-exposure camera relies on temporal multiplexing of different exposures to obtain a single HDR image.

Image classification: The term refers to a process of associating an image to one of a set of predefined categories.

Object classification: Object classification is similar to image classification. It comprises assigning a class (also called a “label”, e.g., “car”, “pedestrian”, “traffic sign”, etc.) to an object.

Object localization: The term refers to locating a target within an image. Specifically in the context of 2D object detection, the localization comprises the coordinates of the smallest enclosing box.

object detection: Object detection identifies an object and its location in an image by placing a bounding box around it.

Segmentation: The term refers to pixel-wise classification enabling fine separation of objects.

object segmentation: Object segmentation classifies all of the pixels in an image to localize targets.

Image segmentation: The term refers to a process of dividing an image into different regions, based on the characteristics of pixels, to identify objects or boundaries.

Bounding Box: A bounding box (often referenced as “box” for brevity) is a rectangular shape that contains an object of interest. The bounding box may be defined as selected border's coordinates that enclose the object.

Box classifier: The box classifier is a sub-network in the object detection neural network which assigns the final class to a box proposed by the region proposal network (RPN). The box classifier is applied after ROI pooling and share some of its layers with the box regressor. In the present disclosure, the architecture of the box classifier follows the principles of “networks on convolutional feature maps”.

Box regressor: The box regressor is a sub-network in the object detection neural network which refines the coordinates of a box proposed by the region proposal network (RPN). The box regressor is applied after ROI pooling and shares some of its layers with the box classifier. The architecture of the box regressor follows the principles of “networks on convolutional feature maps”.

Mean Average Precision (mAP): The term refers to a metric used to evaluate object detection models.

An illumination histogram: An illumination histogram (brightness histogram) indicates counts of pixels in an image for selected brightness values (typically in 256 bins).

Objectness: The term refers to a measure of the probability that an object exists in a proposed region of interest. High objectness indicates that an image window likely contains an object. Thus, proposed image windows that are not likely to contain any objects may be eliminated.

RCNN: “Acronym for “region-based convolutional neural network” which is a deep convolutional neural network.

Fast-RCNN: The term refers to a neural network that accepts an image as an input and returns class probabilities and bounding boxes of detected objects within the image. A major advantage of the “Fast-RCNN” over the “RCNN” is the speed of objects' detection. The “Fast-RCNN” is faster than the “R-CNN” because it shares computations across multiple region proposals.

Region-Proposal Network (RPN): An RPN is a network of unique architecture configured to propose multiple objects identifiable within a particular image.

Faster-RCNN: The term refers to a faster offshoot of the Fast-RCNN which employs an RPN module.

Two-stage object detection: In a two-stage object-detection process, a first stage generates region proposals using, for example, a region-proposal-network (RPN) while a second stage determines object classification for each region proposal.

Non-maximal suppression: The term refers to a method of selecting one entity out of many overlapping entities. The selection criteria may be a probability and an overlap measure, such as the ratio of intersection to union.

Learned auto-exposure control: The term refers to determination of auto-exposure settings based on feedback information extracted from detection results.

Reference auto-exposure control: The term refers to learned auto-exposure control using only one SDR image as disclosed in U.S. patent application Ser. No. 17/722,261.

HDR-I pipeline: A baseline HDR pipeline implementing a conventional heuristic exposure control approach.

HDR-II pipeline: A baseline HDR pipeline implementing learned auto-exposure control.

The traditional approach to tackle high-dynamic-range (HDR) challenges is to use an HDR image sensor coupled with a hardware image signal processor (ISP) and an auto-exposure control system, each of them being designed independently. More precisely, the HDR image sensor captures multiple exposures that are fused and processed in image space by an ISP. The output of the ISP is a single HDR color image which is consumed by a computer vision module that has been designed and trained independently of the other components in the pipeline. Each individual capture in this pipeline, acquired at a different exposure, covers a low dynamic range (LDR) image, e.g., not exceeding 70 dB per image, while the total dynamic range covered by the set of LDR images covers a larger dynamic range. The fusion algorithm that produces the image output (i.e., the fused image) from the set of LDR captures in image space, is typically designed in isolation of the other components of the vision pipeline. In particular, it is not optimized for the computer vision task at hand, be that detection, segmentation, or localization.

Related work on auto exposure control for single low dynamic range (LDR) sensor, high dynamic range imaging using exposure fusion, and object detection is briefly discussed below. The prior art primarily treats exposure control and perception as independent tasks which can lead to failure in high contrast scenes.

### Auto Exposure Control

Commercial auto exposure control systems run in real time on either the sensor or the ISP hardware and use proprietary algorithms that are not publicly available. Classical exposure control algorithms typically rely on image statistics and optimal control theory to determine exposure parameters. However, the chosen parameters can often be detrimental for perception tasks due to excessive motion blur from long exposure time, or excessive noise due to high sensor gain. The present method relies on multiple exposures and learns to utilize robust features from different exposure sets to perform robust object detection.

Exposure Fusion for High Dynamic Range Imaging

The dynamic range of real-world scenes is significantly greater than what current sensors cover. Therefore, a single exposure is insufficient for most real-world driving scenarios (e.g., tunnel entrances and exits). Exposure fusion is one of several strategies for capturing the large range of illuminations with multiple exposures. Single exposure capture cameras typically apply image-dependent metering strategies to capture the largest dynamic range possible, while multi-exposure cameras rely on temporal multiplexing of different exposures to obtain a single HDR image. The present disclosure applies fusion in the feature domain, driven by a detection loss function, without needing to reconstruct a single HDR image.

### Object Detection Networks

Object detection networks can be classified into single-stage and two-stage meta-architectures based on how the inputs are chosen for object classification and regression. In single-stage models, each cell of the feature map is considered for potential object category with different bounding box sizes then further refined and classified. During the first stage of a two-stage detector, the feature map is used for detecting regions of interest where objects can potentially be found. The potential regions are then cropped and fed to a detection head that performs the final bounding box regression and classification. The disclosed method is demonstrated using the popular Faster-RCNN meta-architecture with a custom lightweight 28-layer ResNet backbone split into two stages.

### Learning-based HDR Imaging and Perception

Deep learning for HDR has primarily investigated generating HDR from a single LDR, HDR from multi-exposure fusion of LDR, and learned capture techniques. A few works propose to combine HDR imaging with perception tasks. For example, one known method proposes Traffic Lights detection in dual-channel HDR image where the dark channel is used for detection and bright channel for classification. Another known method proposes HDR object detection by converting HDR to LDR images. Some methods consider two differently exposed HDR stereo images for depth estimation. In another known method the auto exposure control is learned to improve object detection performance. In contrast to this work, which relies on a single exposure for an LDR sensor, the present disclosure adopts a multi-exposure fusion and control approach for an HDR sensor. Moreover, the fusion of the individual sub-exposures is done in the feature domain, guided by a downstream loss, instead of the image domain as in conventional HDR fusion.

### HDR IMAGE FORMATION

According to conventional image space exposure fusion, typical HDR image pipelines produce an HDR raw image I_{HDR} by fusing n LDR images R₁, . . . , Rₙ, that is

$${I}_{HDR} = ExpoFusion ( {R}_{1} , … , {R}_{n} ) .$$

The LDR images R₁, . . . , Rₙ are recorded sequentially (or simultaneously using separate photo-sites per pixel) as n different recordings of the radiant scene power ϕ_{scene}. Specifically, an image Rⱼ, j ∈ {1, . . . , n), with exposure time tⱼ and gain setting Kⱼ is

$${R}_{j} = max ( ( {ϕ}_{scene} \cdot {t}_{j} + {n}_{pre} ) \cdot g \cdot {K}_{j} + {n}_{post} , {M}_{white} ) ,$$

where g is the conversion factor of the camera from radiant energy to digital number for unit-gain, nₚᵣₑ and nₚₒₛₜ are the pre-amplification and post-amplification noises, and M_{white} is the white level, i.e., the maximum sensor value that can be recorded.

The fused HDR image is formed as a weighted average of the LDR images,

$${I}_{HDR} = {\sum }_{j = 1}^{n} {w}_{j} \cdot {R}_{j}$$

where the wⱼ are per-pixel weights such that pixels that are saturated are given a zero weight.

The role of the weights is to merge content from different regions of the dynamic range in a way that reduces artifacts, in particular noise. A popular approach is to choose the weights wⱼ such that I_{HDR} is the minimum variance unbiased estimator.

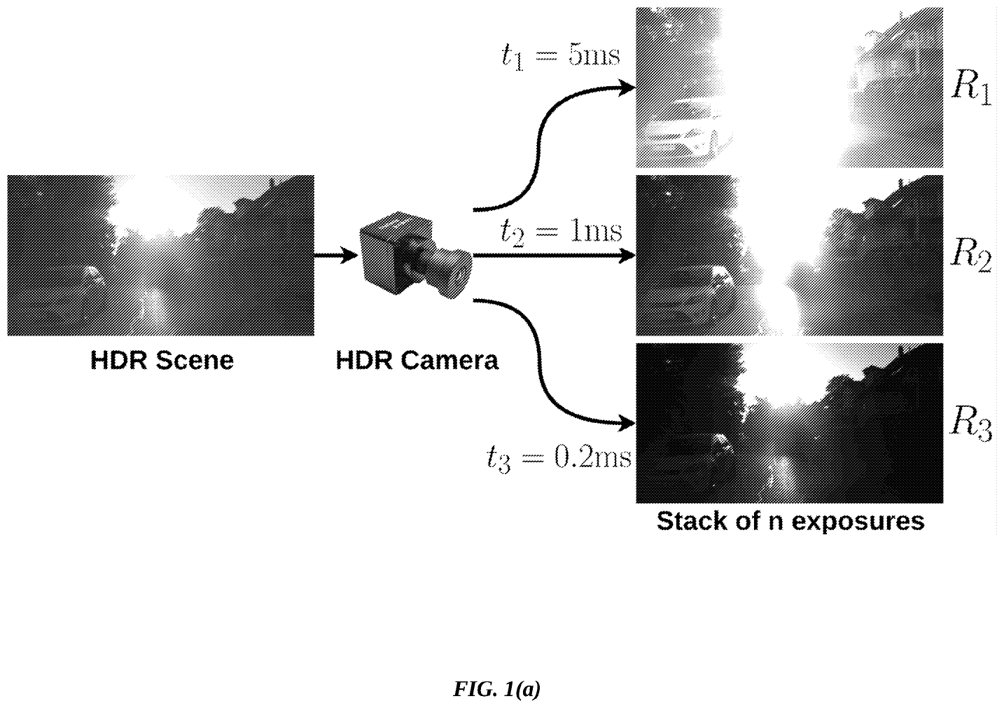

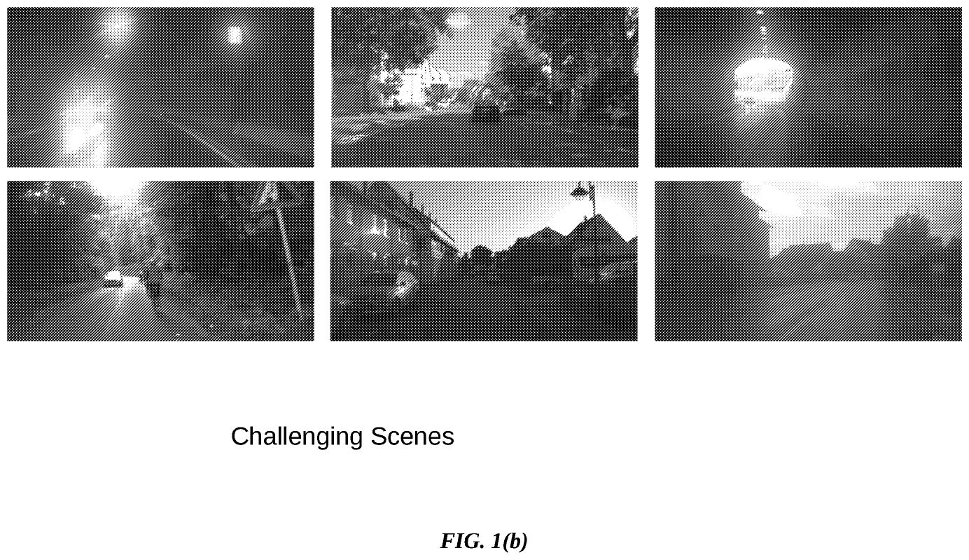

The multi-exposure vision pipeline is trained in an end-to-end fashion, including a learned exposure selection module as well as the simulation of the capture process based on exposure settings produced by the exposure control. This pipeline training is driven by detection losses typically used in object detection training pipelines. The exposure control is learned for n>1 sub-exposure captures (as illustrated in FIG. 1) jointly with feature-based fusion. It is demonstrated that this outperforms existing single-capture auto-exposure and HDR fusion approaches. The proposed feature-domain exposure fusion and corresponding exposure control are validated with a test set of automotive scenarios; the method is compared with existing HDR reconstruction methods. The proposed method outperforms the conventional exposure fusion and auto-exposure methods by more than 2% mAP. The algorithm choices are validated with extensive ablations experiments that test different feature-domain HDR fusion strategies.

To summarize, the disclosure provides:

a neural fusion approach for high dynamic range object detection as an alternative to image space exposure fusion;
a new type of attention module to perform feature fusion, local cross-attention fusion, driven by a downstream detection task;
a generalized neural exposure control module (multiple exposures), and
validation that the exposure fusion and control strategy outperform the existing auto exposure and image space exposure fusion for automotive object detection across all tested scenarios.

In an alternative approach to HDR object detection, according to the present disclosure, multi-exposure captures are not merged on the sensor but fused in the feature domain. The proposed pipeline reasons on features from separate exposures and relies on a learned neural exposure trained end-to-end along with all modules of the pipeline, driven by the detection loss.

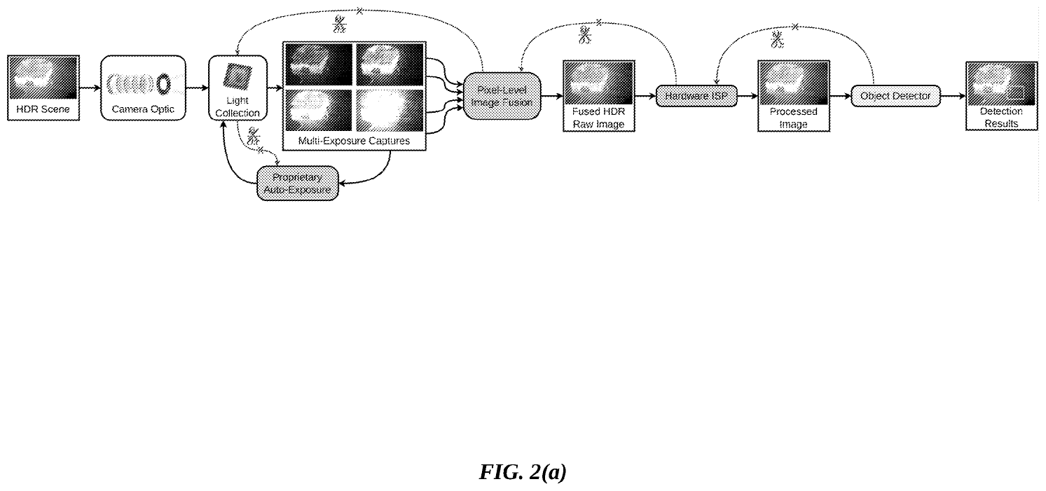

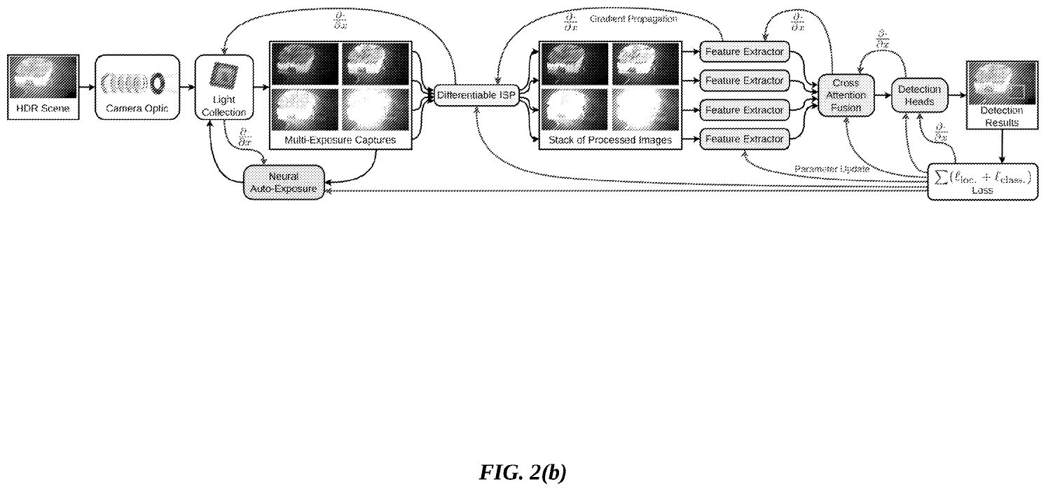

FIG. 2(a) illustrates conventional HDR exposure fusion performed in image space, before object detection.

FIG. 2(b) illustrates an alternative approach to HDR object detection, where multi-exposure captures are not merged on the sensor but fused in the feature domain. The proposed pipeline reasons on features from separate exposures and relies on a learned neural exposure trained end-to-end along with all modules of the pipeline, driven by the detection loss.

### NEURAL EXPOSURE FUSION

A conventional HDR pipeline (FIG. 2a) is formalized then the novel HDR pipeline (FIG. 2b) is introduced. An HDR image may be formalized as the result of a fusion of n LDR raw images (n>1) which are recorded in a burst following an exposure bracketing scheme. This image space exposure fusion has been designed independently of the vision task. As an alternative, a method of feature-space exposure fusion and control is considered where features from all exposures are recovered before fusion and the features are exchanged with the knowledge of semantic information. In other words, feature fusion is supervised by the downstream IoU loss. Closing the loop, the exposures of the n exposures of the next frame are predicted with a network that is also supervised by semantic feedback from the detections of the current frame.

More formally, a conventional HDR object detection pipeline (FIG. 2a) is expressed as the following composition of operations

$${( {b}_{i} , {c}_{i} , {s}_{i} )}_{i ∈ I} = OD ( {ISP}_{hw} ( ExpoFusion ( {R}_{1} , … , {R}_{n} ) ) ) ,$$

where the bᵢ are the detected bounding boxes and cᵢ and sᵢ the corresponding inferred classes and confidence scores, the symbols OD, ISP_{hw} and ExpoFusion denote the object detector, the hardware ISP and the image space exposure fusion, and (R₁, . . . , Rₙ) are the raw LDR images recorded by the HDR image sensor. It is noted that the exposure fusion outputs a single image that is ingested by the downstream pipeline to extract features.

In contrast, the present method uses the following feature-space fusion

$${( {b}_{i} , {c}_{i} , {s}_{i} )}_{i ∈ I} = {OD}_{late} ( Fusion ( {OD}_{early} ( ISP ( {R}_{1} ) ) , … , {OD}_{early} ( ISP ( {R}_{n} ) ) ) ) .$$

Instead of using a fused HDR image, the method learns to extract features for each exposure that are fused in feature-space. The operator OD_{early} is the feature extraction, and ODₗₐₜₑ is the downstream part of the object detector. The symbol Fusion denotes the neural fusion, which fuses feature maps from different exposures. The method relies on a differentiable ISP for each of the n raw sub-exposures (R1, . . . , Rₙ). The entire model is trained end-to-end as a differentiable multi-exposure HDR capture and vision pipeline where the multi-exposure control, feature extraction, fusion and the heads of the object detector are trained jointly. Specifically, for the object detector, the Faster-RCNN meta-architecture with a 28-layer variant of ResNet is used as feature extractor. Note that, departing from the single-exposure method in Onzon et al., the method captures and extracts features from multiple different exposures and uses a feature-based fusion for these multiple exposures. As such, the fusion of the information extracted from the different exposures is critical for the proposed model to be effective, which is discussed below.

### Exposure Feature Fusion with Local Cross-Attention

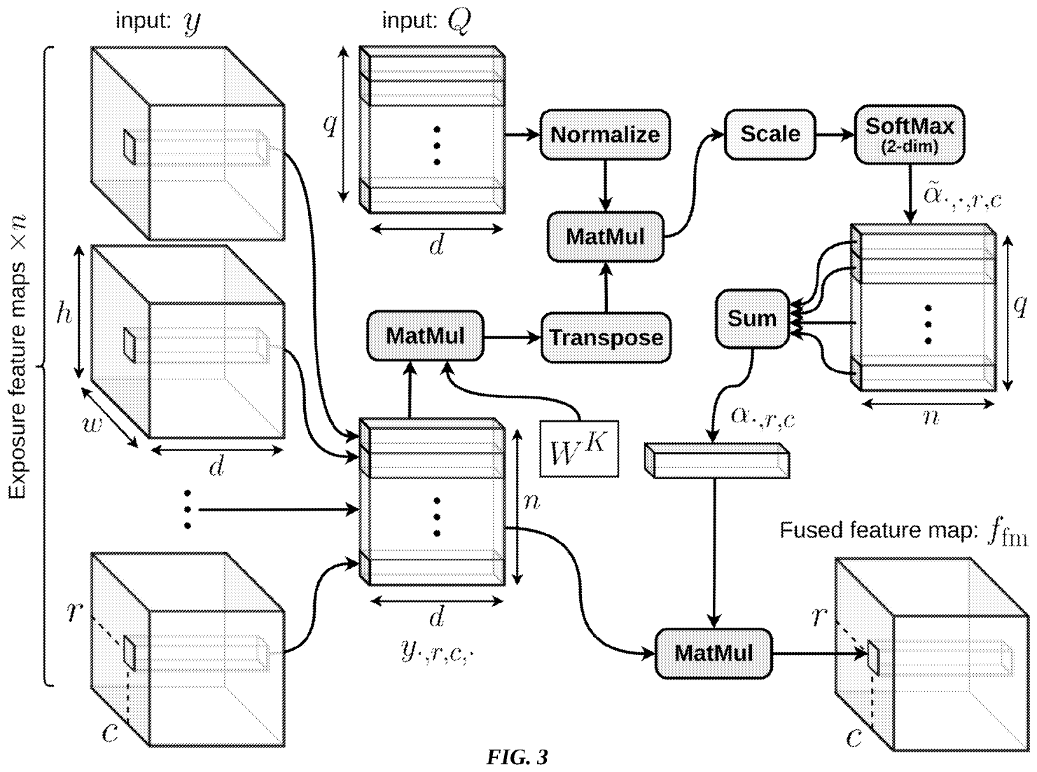

FIG. 3 illustrates the local cross-attention fusion of the present disclosure where cross attention with learned query matrix Q is applied locally to n-feature maps stacked into y, at row r and column c, resulting in the weight vector α_{.,r,c}, which is used to produce the vector at location (r, c) of the fused feature map ƒ_{fm}. The softmax is normalized with respect to both axes.

A first step is to extract a stack of feature maps for each exposure; for exposure j:

$${y}_{j , r , c , k} = {( FE ( ISP ( {R}_{j} ) ) )}_{r , c , k} ,$$

where r, c are spatial coordinates, and k ∈ {1, . . . , d} is a feature channel resulting from feature extractor FE.

Subsequently, the n exposure feature maps corresponding to the different exposures together are fused by performing a locally weighted average with local weights that are computed according to attention maps. These attention maps are stacked together across the first-dimension axis into the tensor α_{j,r,c}. The fused feature map ƒ_{fm} is then computed by applying a weighted sum reduction across the first dimension, that is

To compute the α_{j,r,c}, a new attention module, called local cross-attention fusion, is used. The attention module is inspired by the query-key-value attention module.

The keys and the values are feature vectors from the feature maps y and the queries are trainable parameters. The module attends to the feature vectors across exposures and across a set of learned queries. This means that for each row r and column c of the feature map, the matrix y_{.,r,c} is considered such that for l≤j≤n and l≤k≤d, (y_{.,r,c,})_{j,k}=y_{j,r,c,k}. The attention module is applied locally to produce the n-dimensional local attention weight vector α_{.,r,c};

$${α}_{. , r , c} = Attention ( Q , {y}_{. , r , c , .} ) ,$$

where Q is a learned query matrix of shape (q, d), which is shared across all locations (r, c).

Specifically, for each row r=1, . . . , hand each column c=1, . . . , w we first compute the key matrix K^{(r,c)} at location (r, c) with the following matrix multiplication

$${K}^{( r , c )} = {y}_{\cdot , r , c , \cdot } {W}^{K} ,$$

where W^{K} is the learnable projection matrix with d rows and d columns for the keys. The queries are not projected because they are directly learned, so projecting them would be redundant. As an intermediate step, we compute the expanded attention map of shape (q, n, h, w). At each location (r, c) we represent by the matrix [symbol] _{;;r,c}, which is computed as

$${\cdot , \cdot , r , c}_{} = softmax ( \frac{{( {K}^{( r , c )} )}^{T}}{\sqrt{d}} )$$

The matrix [symbol] is the normalized version of matrix Q, where each row of Q has been divided by its l²norm. The result of the above softmax operation is a matrix of shape(q, n). We note that in this softmax operation, we apply the normalization of the softmax with respect to both axis of the matrix, i.e., if z is a q×n matrix,

$${softmax ( z )}_{i , j} = \frac{{e}^{{z}_{i , j}}}{{\sum }_{i ′ = 1}^{q} {\sum }_{j ′ = 1}^{n} {e}^{{z}_{i ′ , j ′}}} ,$$

while in the standard query-key-value attention module, the normalization is only applied with respect to the second axis.

Finally, the stacked attention map α is obtained by summing the expanded attention map along its first axis, that is

$${α}_{j , r , c} = {\sum }_{i = 1}^{q} {i , j , r , c}_{}$$

The final step to compute the fused feature map is analog to the matrix multiplication between the softmax output and the value matrix. Hence, the cross-attention fusion may be viewed as a variant of the query-key-value attention module, where the role of the value is played by y_{.,r,c,.}.

### Fused Features Proposals

The fused feature map is input to the RPN, as well as to the ROI pooling operation, to produce the M ROI feature vectors ƒ_{ROL,i}, i ∈ {1, . . . , M}, corresponding to each of the M region proposals, i.e.,

$${f}_{ROI , i} = NoC ( RoiPool ( {f}_{fm} , RPN ( {f}_{fm} , i ) ) ) .$$

The symbol RPN(ƒ_{fm},i) refers to the region proposal number i produced by the RPN based on the fused feature map ƒ_{fm}, and the symbol NoC refers to the network recovering convolutional feature maps after ROI pooling based on ResNet as a feature extractor. Then, the ROI feature vector is used as input to both detection heads, i.e., the box classifier and the box regressor. Their outputs are:

$${( {p}^{k , i} )}_{k ∈ \{ 0 , … , K \}} = Cls ( {f}_{ROI , i} ) , i ∈ \{ 1 , … , M \} , and$$

$${( {t}^{k , i} )}_{k ∈ \{ ` , … , K \}} = Loc ( {f}_{ROI , i} ) , i ∈ \{ 1 , … , M \}$$

where p^{k,i} is the estimated probability of the object in the region proposal i to belong to class k, and t^{k,i} is the bounding box regression offsets for the object in the region proposal i assuming it is of class k (the class k=0 corresponds to the background class). The operators Cls and Loc refer to the object classifier and the bounding box regressor respectively. At inference time, following reference [40], a per-class non-maximal suppression step on the set of bounding boxes

$$\{ {t}^{k , i} \vert k = 1 , … , K ; i = 1 , … , M \} ,$$

is performed. The method is evaluated with different fusion variants.

### Neural Exposure Selection

To select the exposures of the multiple captures acquired per HDR frame, an exposure prediction network is trained. The exposure prediction network takes as input a stack of 59 multi-scale histograms of the n input captures of the last frame forming a tensor of shape [256, 59n] per exposure. This tensor is used as input to the lightweight exposure selection network, which predicts multiple exposure times. Specifically, the network starts with three 1-dimensional convolutional layers, where the 1D convolution is applied along the first dimension of the tensor, followed by three dense layers. The exposure of each of the n captures of the next time step is predicted such that the logarithms of the exposures of the captures are evenly distributed (more details are provided below). Note that the network weights are learned with semantic feedback from the detection loss at the end of the pipeline.

### Differentiable ISP

The image signal processor (ISP) for all fusion strategies comprises a sequence of conventional ISP modules with the following processing steps: contrast stretching, demosaicing, image resizing, color correction, low frequency denoising, sharpening, contrast enhancing. Additional details are provided in the Supplemental Document. The ISP blocks are implemented as differentiable operations to backpropagate through them; other differentiable ISP modules may be used.

### TRAINING

### HDR Training Dataset

Training and testing of the proposed method is based on a dataset of automotive HDR images captured with the Sony IMX490 sensor mounted with a 60°-FOV lens behind the windshield of a test vehicle. The sensor produces images that are 24 bits when decompanded. Training examples are constructed from two successive images from sequences of images taken while driving.

The training dataset contains 18790 examples.

TABLE 1
HDR test data distributions

| Sunny | Cloud/Rain | Backlight | Tunnel | Dusk | Night | Total |
|---|---|---|---|---|---|---|
| 864 | 184 | 88 | 120 | 228 | 512 | 1996 |

The test set is partitioned into six distinct subsets depending on the illumination conditions. This partition allows to compare the methods with respect to these illumination conditions. Counts of examples in each of the six subsets are indicated.

### Network Training

Mini sequences of two consecutive decompanded 24-bit raw images are used to train the end-to-end HDR object detection method. A further exposure shift κ_{shift} is applied to the first exposure. The set of n 12-bit LDR images used for inference on the successive frames are simulated by multiplying the learned base exposure time t_{base} with the exposure difference dⱼ, tⱼ=t_{base}·dⱼ for j ∈ {1, . . . , n}. For the HDR baselines (see “Baseline Detection Pipelines” below) the predicted exposure value is used to directly simulate a single 20-bit HDR image. Other automotive datasets, pretrained ISP and object detector are used and the full pipeline is fine-tuned jointly on the training dataset with challenging scenarios. Additional details about the training methodology are provided below.

### EVALUATION OF THE DISCLOSED METHOD

Different variants of the proposed neural exposure fusion approach are compared to the conventional HDR Imaging and detection pipelines, and alternative fusion approaches, in diverse HDR scenarios. The test set comprises 1996 pairs of consecutive HDR frames taken under a variety of challenging conditions. The second frame of each mini sequence is manually annotated with 2D bounding boxes. The examples are distributed across the following different illumination categories: sunny, cloud/rain, backlight, tunnel, dusk, night. Table 1 provides the test set distribution of the instance counts in these categories. An exposure shift κ_{shift} is simulated for each image pair. In contrast to the training pipeline, a fixed set of exposure shifts

κ_{shift ∈} 2^{{-15, -10, -5, 0, 5, 10, 15}} is used for each frame and an average detection performance is determined over them. The evaluation metric is the object detection average precision (AP) at 50% IoU, which is computed for the full test set.

TABLE 2
HDR object detection evaluation for different neural exposure fusion strategies
compared to conventional HDR Imaging and object detection pipelines

| | | Classes | | | | | |
|---|---|---|---|---|---|---|---|
| | | Bus | Car | | Traffic | Traffic | |
| Methods | Bike | & Truck | & Van | Person | Light | Sign | mAP |
| LDR Gradient AE [43] | 9.3 | 5.5 | 27.7 | 16.3 | 14.7 | 14.1 | 14.6 |
| LDR Average AE [1] | 13.5 | 7.1 | 40.4 | 24.0 | 21.6 | 27.3 | 22.3 |
| Onzon et al. [34] (LDR) | 24.6 | 15.6 | 72.3 | 43.5 | 39.7 | 52.3 | 41.3 |
| HDR I | 20.5 | 12.2 | 59.1 | 34.7 | 32.7 | 37.4 | 32.8 |
| HDR II | 23.4 | 15.2 | 72.1 | 43.7 | 41.8 | 52.8 | 41.5 |
| Deep HDR [19] | 25.6 | 16.7 | 72.2 | 44.6 | 43.4 | 48.7 | 41.9 |
| Early Fusion (ours) | 26.1 | 15.8 | 73.9 | 46.2 | 42.6 | 54.8 | 43.2 |
| Late Fusion (ours) | 27.5 | 14.2 | 73.8 | 47.2 | 42.8 | 53.3 | 43.0 |
| Local Cross Attention | 26.8 | 16.6 | 74.3 | 47.0 | 44.4 | 56.3 | 44.2 |
| (ours) | | | | | | | |

The present feature fusion strategies allow significant gains in mAP compared to pixel-level fusion methods, and improvements in most of the six considered object classes.

### Baseline Detection Pipelines

Results of the present method are compared with those of recent HDR and LDR (+auto-exposure) baseline methods. Specifically, the comparison is against custom HDR strategies HDR I, HDR II and Deep HDR. All three pipelines synthesize an HDR Image by performing pixel fusion. Each of the three variants use the same differentiable ISP module (see Section 4.4) and object detector and is jointly finetuned on the training dataset for fair comparison. HDR I and HDR II differ in exposure selection method. While the variant HDR I implements a conventional heuristic exposure control approach, the variant HDR II uses a learned exposure control. For Deep HDR a learned exposure selection is used as with HDR II. Comparison is made to three LDR object detection pipelines that differ in the exposure selection method. LDR Gradient AE uses the method from, LDR Average AE uses a method based on the average value, and a third LDR object detection pipeline. In the following, the HDR pipelines to which comparison is made are described.

### HDR I—Average AE

For this baseline, no feature fusion is performed, instead the LDR captures are merged to an HDR Image before the ISP. The exposure selection method follows a heuristic based on the average pixel value of the current frame. At time step t, assuming the current exposure value is eₜ and the average pixel value of the fused HDR Image is Īₜ, the next exposure value eₜ₊₁ is computed as:

$${e}_{t + 1} = 0.5 \cdot {M}_{white} \cdot {\overline{I}}_{t}^{- 1} \cdot {e}_{t} ,$$

where M_{white} is the white level of the HDR sensor.

### HDR II—Learned Exposure

This approach is similar to HDR I in that the LDR captures are merged to an HDR Image before the ISP rather than performing feature fusion. It differs in the method to select exposure. Here exposure selection uses the learned Histogram NN model instead of the heuristic.

TABLE 3
Comparison of object detection performances (in
mAP) with respect to the illumination conditions.

| | Illumination conditions | | | | | |
|---|---|---|---|---|---|---|
| | | Cloud | | | | |
| Methods | Sunny | & Rain | Backlight | Tunnel | Dusk | Night |
| LDR Gradient | 16.2 | 11.0 | 11.4 | 11.1 | 13.7 | 12.2 |
| AE [43] | | | | | | |
| LDR Average | 22.8 | 14.0 | 17.5 | 8.9 | 25.3 | 24.2 |
| AE [1] | | | | | | |
| Onzon et al. [34] | 45.7 | 33.0 | 31.6 | 31.4 | 39.5 | 37.2 |
| (LDR) | | | | | | |
| HDR I | 36.3 | 18.0 | 24.4 | 22.7 | 33.0 | 27.4 |
| HDR II | 45.2 | 32.8 | 28.7 | 37.4 | 39.2 | 37.1 |
| Deep HDR [19] | 45.6 | 36.3 | 32.3 | 42.5 | 39.2 | 36.8 |
| Early Fusion | 46.7 | 33.9 | 33.9 | 40.0 | 42.1 | 39.2 |
| (ours) | | | | | | |
| Late Fusion | 47.0 | 31.6 | 31.9 | 37.6 | 41.4 | 37.5 |
| (ours) | | | | | | |
| Local Cross | 47.8 | 32.8 | 33.9 | 39.1 | 42.5 | 39.5 |
| Attention (ours) | | | | | | |

Each of the tested methods is evaluated for each of the subsets indicated in Table 1. This allows to better understand the strength and weaknesses of each method. Our proposed methods allow to make gains in four out of the six tested conditions.

### Alternative Fusion Strategies

The present method is validated by comparing to the following alternative fusion strategies which are briefly described below (see the Supplement for the detailed description of each strategy).

### Early Fusion Strategy

For this strategy, the feature maps are fused together at the end of the feature extractor. A variant of the local cross attention fusion is considered with a drop-in replacement of the local cross attention fusion module by a maximum reduction across the n exposures, i.e., the following fused feature map is considered,

$${f}_{ef , ( r , c , k )} = {max}_{j = 1 , … , n} {y}_{j , r , c , k}$$

### Late Fusion Strategy

The late fusion strategy consists in running the object detector for each of the n images independently in parallel. The final NMS stage is performed on the union set of all second stage detections.

### EVALUATION

### Ablation Experiments

Comparisons with the early fusion and late fusion methods described in Section 6.2 are conducted. The proposed method, local cross-attention fusion, performs overall better than these two alternatives by respectively 1% and 1.2% mAP. This is confirmed by a higher AP score across most of the considered object classes, see Table 2. Specifically, the proposed feature fusion strategy outperforms the pixel-level fusion methods in five out of the six considered object classes. These experiments confirm the effectiveness of the proposed fusion block and other fusion strategies.

### Quantitative and Qualitative Analysis

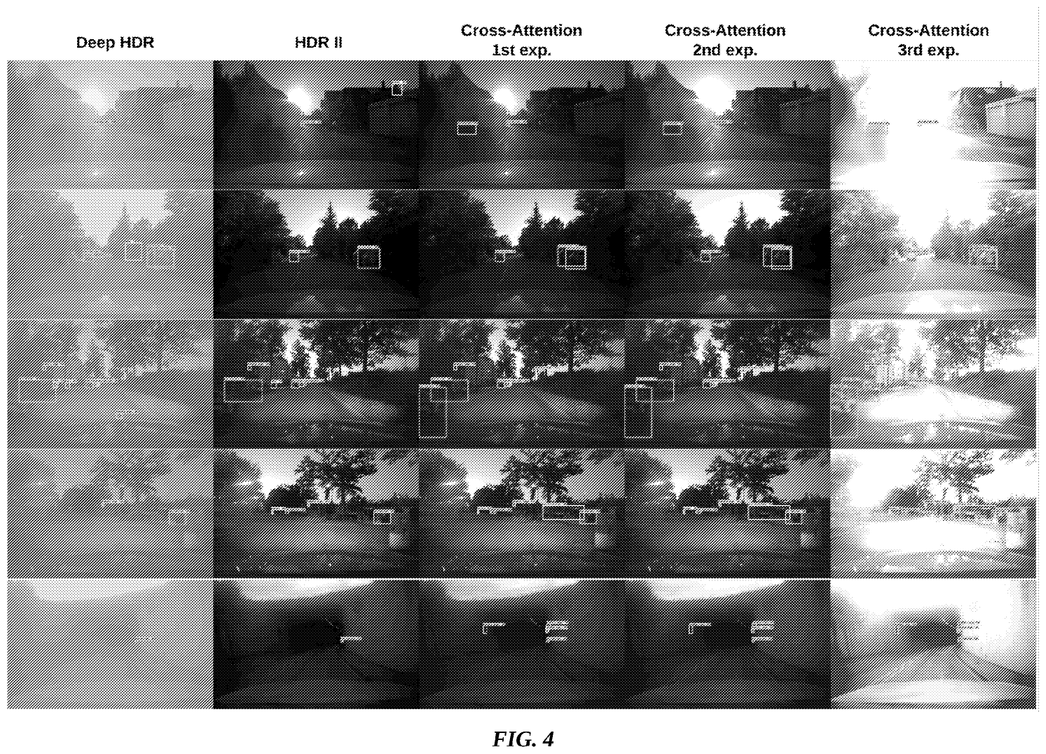

Next, the proposed method is compared to the baseline detection methods. The findings are reported in Table 2. These evaluations validate that the proposed neural fusion variants, which are using three exposures, outperform the HDR baselines. The proposed method is overall best with more than 11% mAP, 2.8% mAP and 2.3% mAP respectively compared to HDR I, HDR II and Deep HDR. FIG. 4 shows qualitative results that complement the quantitative analysis. Objects in the darkest parts of the image can be missed by HDR II and Deep HDR methods, while the proposed Local Cross Attention Fusion method manages to detect them. The presence of the highest exposure capture is particularly useful in such cases. Such an instance can be seen in the first row of images in FIG. 4, where a particularly difficult to distinguish vehicle is in front of a house on the left side of the image. This vehicle is not detected by HDR II and Deep HDR methods, but the proposed Local Cross Attention Fusion method manages to detect it. This is also the case for a vehicle parked on the left of the image in the second row of images, whose detection escapes the HDR II method. Hallucinating HDR images, the Deep HDR method suffers from false negatives in this particularly dark part of the image.

Partially occluded objects are another challenge for the detection in high dynamic range scenes. Occlusions can be due to the presence of other objects masking the object of interest, as is the case in the fourth row of images in FIG. 4 where a truck parked in a poorly lit area is partially occluded by a tree and a low wall. Despite this, the proposed method manages to detect this truck, where the Deep HDR and HDR II methods fail to detect it. Finally, some objects can also be occluded because they exit the camera field of view, so that only a small part of the object is visible. When combined with the fact that this small part of the object is poorly exposed because the camera must be able to properly expose a high dynamic range image, this makes the object particularly difficult to detect. This is the case, for example, with a car in the third row of FIG. 4, which disappears to the left of the image. The Deep HDR and HDR II methods fail here, while the Local Cross Attention Fusion method manages to detect this object which is very badly exposed and largely occluded. Finally, small objects are known to be a source of difficulty for object detectors. This difficulty is even more pronounced in a high dynamic range situation, such as the tunnel entrance visible in the last row of FIG. 4, where there are small traffic signs at the entrance of the tunnel, which the HDR II and Deep HDR methods fail to detect, but which are well detected by the Local Cross Attention Fusion method.

### Impact of Illumination Conditions

The influence of the illumination conditions on the effectiveness of the different methods is also assessed. The findings are reported in Table 3. The methods are tested for each the six different subsets of the test set in Table 1. It is determined that the present method allows significant gains compared to pixel-level fusion across four out of the six considered illumination conditions: sunny, backlight, dusk and night.

### Differentiable ISP

In the following, we discuss the differentiable ISP pipeline used in the proposed method. The ISP we employ consists of a sequence of multiple individual blocks. The first ISP block is a contrast stretcher applied to the RAW image. This contrast stretcher performs a pixel-wise affine mapping based on a lower and upper percentile of all RAW values. The second step of the ISP is demosaicing, creating a three channel color image. The demosaicer is a differentiable variant of bilinear demosaicing. The third step is a resize operation of the image to a shape with height 600 pixels and width 960 pixels. The fourth step is a pixel-wise power transform x→x^{γ} with γ=0.8where γ is not learned for this step.

The fifth step is the application of color correction matrix, i.e., for each pixel, the (r, g, b) vector, of the red, green and blue values, is mapped linearly with a 3×3matrix which is learned during training. The matrix is initialized to the identity mapping. The sixth step is a color space transform to the color space YcbCr. The seventh step is a low-frequency denoiser. More precisely, it is a denoiser based on a difference of Gaussian (DoG) filters. To this end, we extract a detail image as

$${I}_{detail} = {K}_{1} * {I}_{input} - {K}_{2} * {I}_{input} ,$$

where * is the convolution operator and K₁and K₂are Gaussian kernels with standard deviations σ₁ and σ₂ respectively, which are learned and such that σ₁<σ₂.

The output of the DoG denoiser is

$${I}_{output} = {I}_{input} - g \cdot {I}_{detail} \cdot {1}_{\vert {I}_{detail} \vert ⩽ t} ,$$

where the parameters g and t are learned.

The eighth step is a color conversion back to the previous RGB color space. The ninth step is a thresholded unsharp mask filter where the standard deviation of the Gaussian filter, the magnitude, and the threshold are learned. The tenth step is a pixel-wise affine transform with learned parameters. Finally, the last step is a learned gamma correction step.

### Additional Training Details

In this section, we provide further details on the training procedure for the proposed model.

### Pretraining

The feature extractor was pretrained on ImageNet 1K. The object detector was pretrained jointly with the ISP with several public and proprietary datasets. Among the public datasets that were used for pretraining are MS-COCO, Kitti, Cityscapes and BDD. The resulting pretrained ISP and object detector pipeline is used as a starting point for the training of all the experiments reported in the paper.

### Optimizer Hyperparameters

We train using the stochastic gradient descent with momentum of value 0.9. We use a learning rate with exponential decay after an initial stage of constant learning rate for the first 10,000 iterations. In the initial stage, the learning rate is kept constant at 10⁻⁴. Thereafter, the learning rate is multiplied by 0.7¹⁰^{^{−4}} at each training iteration, such that the learning rate is shrunk by a factor 0.7 every 10,000 iterations. We train for 160,000 iterations with a batch size of one training example.

### Multi-Exposure Training Pipeline

In our training pipeline for multi exposure object detection, we simulate n=3LDR captures of the same scene, I_{lower}, I_{middle}, Iᵤₚₚₑᵣ, the captures with the lower, middle and upper exposure. The middle exposure capture I_{middle} is simulated, except that instead of sampling the logarithm of the exposure shift in the interval [log0.1, log10], we sample in the interval [−15 log 2,15 log 2]. The two other captures, I_{lower} and Iᵤₚₚₑᵣ, are simulated the same way, except that on top of the exposure shift, an extra constant exposure shift is applied, d_{lower} and dᵤₚₚₑᵣ respectively. In our experiments we chose d_{lower}=16⁻¹ and dᵤₚₚₑᵣ=16.

### Alternative Fusion Strategies

Next, we provide detailed descriptions of alternative fusion approaches.

### Local Cross Attention RPN Fusion

In another variant of the local cross attention fusion:

Here the region proposals are computed independently for each exposure. The union set of all proposals is used to crop an aggregation of the feature maps ƒ_{agg} produced by the feature extractor. We call this variant LocalCrossAttentionRPNFusion.

More specifically, ƒ_{agg} consists in the concatenation of n fused feature maps produced by local cross attention fusion with a distinct query matrixQ^{(j)} for each of the n fused feature map.

We treat the different exposure pipelines separate until the Region Proposal Network (RPN). The network predicts different first-stage proposals for each stream j, which leads to n·M proposals in total. Based on them, the Rol pooling layer crops out of the aggregated fused feature map ƒ_{agg}.

Here, in Local Cross Attention RPN Fusion, ƒ_{agg} consists in the concatenation of n fused feature maps ƒ_{fm,(r,c,k)}⁽¹⁾, . . . , ƒ_{fm,(r,c,k)}⁽ⁿ⁾ along the last axis, i.e., for k ∈ {1, . . . , nd},

$${f}_{agg , ( r , c , k )} = {f}_{fm , ( r , c , k mo d d )}^{( ⌊ ( k - 1 ) / d ⌋ + 1 )} ,$$

where mod is the modulo operator, and each fused feature map ƒ_{fm,(r,c,k)}, with j ∈ {1, . . . , n}, is computed as,

$${f}_{fm , ( r , c , k )}^{( j )} = {\sum }_{{j}^{′} = 1}^{n} {α}_{j ′ , r , c}^{( j )} \cdot {y}_{j ′ , r , c , k} and {α}_{\cdot , r , c}^{( j )} = Attention ( {Q}^{( j )} , {y}_{\cdot , r , c ,} ) ,$$

similarly to above. A single second stage box classifier, which is applied on the full list of cropped feature maps yields the second stage proposals, that is

$${f}_{ROI , i , j} = NoC ( RoiPool ( {f}_{agg} , RPN ( FE ( ISP ( {R}_{j} ) ) ) , i ) ) .$$

We employ a loss without modifications for this fusion strategy.

### Late Fusion Strategies with Modified Losses

We now give more details about the Late Fusion method, and we compare it to two enhanced variants. The Late Fusion method is referred to herein as Late Fusion Standard Loss to distinguish it from the two variants, which we refer to as Late Fusion Keep Best and Late Fusion NMS. Each of these three late fusion strategies behave the same at inference time and only differ at training time. Generally speaking, the late fusion strategies treat features of the individual exposures independently, almost until the end of the second stage of the object detector, but just before the final per class non-maxima suppression (NMS) of the detection results (i.e., the per-class box post-processing). At this point, all the refined detection results produced from the n exposures are gathered in a single global set of detections.

Finally, per-class NMS is performed on this global set of detections, producing a refined and non-maxima suppressed set of detections pertaining to the n LDR exposures as a whole, i.e., pertaining to a single HDR scene. The late fusion strategy is evaluated by the standard object detection loss. Here, we further experiment with several alternative losses to improve the late fusion process.

We use temporal mini sequences of two consecutive multi-exposure frames and train all blocks of the computer vision pipeline jointly using the object detection loss, which is a sum of the first stage loss L_{RPN} and second stage loss L_{2ndStage}.

$${L}_{Total} = {L}_{RPN} + {L}_{2 nd Stage} .$$

For the two proposed enhanced late fusion variants, the RPN loss is computed here as the sum of the lowest objectness L_{obj} and localization losses L_{Loc} over all n exposure pipelines computed per anchor α ∈ A, where the set of available anchors A is identical in each stream. As such, the model is encouraged to have high diversity in predictions between different streams and not punished if instances are missed that are recovered by other streams. The RPN loss which we investigate reads as follows,

$${L}_{RPN , prop .} = {\sum }_{a} {min}_{j ∈ \{ 1 , … n \}} ( \frac{1}{{N}_{Obj}} {L}_{Obj} ( {p}_{j , a} , {p}_{a}^{*} ) + \frac{λ}{{N}_{Loc}} {p}_{a}^{*} {L}_{Loc} ( {t}_{j , a} , {t}_{a}^{*} ) ) ,$$

while the standard RPN loss is,

$${L}_{RPN , std .} = {\sum }_{a} ( \frac{1}{{N}_{Obj}} {L}_{obj} ( {p}_{j , a} , {p}_{a}^{*} ) + \frac{λ}{{N}_{Loc}} {p}_{a}^{*} {L}_{Loc} ( {t}_{j , a} , {t}_{a}^{*} ) ) .$$

We compute masked versions of the second stage loss, which differ depending on the chosen late fusion strategy,

$${L}_{{2}^{nd} St . , prop .} = {\sum }_{j = 1}^{n} {\sum }_{i} {α}_{j}^{i} ( \frac{1}{{N}_{Cls}} {L}_{Cls} ( {p}_{j}^{i} , {c}_{j}^{* i} ) + \frac{λ}{{N}_{Loc}} {1}_{{c}_{j}^{* i} ⩾ 1} {L}_{Loc} ( {t}_{j}^{i} , {t}_{j}^{* i} ) ) \qquad ( 1 )$$

$${L}_{{2}^{nd} St . , prop .} = {\sum }_{j = 1}^{n} {\sum }_{i} {α}_{j}^{i} ( \frac{1}{{N}_{Cls}} {L}_{Cls} ( {p}_{j}^{i} , {c}_{j}^{* i} ) + \frac{λ}{{N}_{Loc}} {1}_{{c}_{j}^{* i} ⩾ 1} {L}_{Loc} ( {t}_{j}^{i} , {t}_{j}^{* i} ) ) ,$$

where c*ₕⁱ and t*ⱼⁱ are the GT class and box assigned to the predicted box tⱼⁱ. Here,

$${1}_{{c}_{j}^{* i} ⩾ 1}$$

is equal to 1 when the GT is an object and 0 when it is the background. The coefficients αⱼⁱ are the masks, each of them is set to 0 or 1. For comparison we recall below the standard second stage loss,

$${L}_{{2}^{nd} St . , std .} = {\sum }_{j = 1}^{n} {\sum }_{i} ( \frac{1}{{N}_{Cls}} {L}_{Cls} ( {p}_{j}^{i} , {c}_{j}^{* i} ) + \frac{λ}{{N}_{Loc}} {1}_{{c}_{j}^{* i} ⩾ 1} {L}_{Loc} ( {t}_{j}^{i} , {t}_{j}^{* i} ) ) ,$$

By pruning the less relevant loss components with the introduced masks, the resulting loss better specializes to well-exposed regions in the image, for a given exposure pipeline, while at the same time avoiding false negatives in sub-optimal exposures, as these cannot be filtered out in the final NMS step.

Two alternative methods to define the masks are detailed below.

Strategy I, Keep Best Loss, for each ground truth object, keeps the loss components corresponding to the pipeline that performs best for that ground truth, and prunes the others.

Strategy II, NMS Loss, prunes the loss components based on the same NMS step as performed at inference time.

While Strategy I more precisely prunes the loss across exposure pipelines, resulting in more relevant masks, Strategy II is conceptually simpler, which makes it an interesting alternative to test. We review both strategies in detail below.

### Strategy I: “Keep Best Loss”

In the second stage of the object detector, a subset of the refined bounding boxes is selected for each exposure pipeline. These subsets are merged into a single set of predicted bounding boxes by assigning each box to a single ground truth (GT) object. If the GT is positive (i.e., there is an object to assign to that bounding box), then we first identify the exposure stream j that predicted the bounding box, which received the lowest aggregated loss L_{Agg,j}ⁱ=L_{Cls,j}ⁱ+L_{Loc,j}ⁱ, for this GT object. Afterwards, we only backpropagate the losses for the bounding boxes assigned to this GT object which were predicted by the same pipeline j. As an exception, the losses of all of the bounding boxes that are associated with negative GT (background class) are backpropagated, regardless of which exposure stream predicted them. With the notation from Equation (1), this is

$${α}_{j}^{i} = \{ \begin{matrix}1 , & if {c}_{j}^{* i} ⩾ 1 and ∃ {I}^{′} such that GT ( i , j ) = GT ( {i}^{′} , j ) , \\ 1 , & {L}_{Agg , j}^{i ′} minimal among all predictions for GT , if {c}_{j}^{* i} = 0 , \\ 0 , & otherwise .\end{matrix}$$

### Strategy II: “NMS Loss”

Like in strategy I, here, we get the final detection results after class-wise NMS on the combined set of all predictions. The non-suppressed proposals are the only ones for which the second stage loss gets backpropagated, that is

$${α}_{j}^{i} = \{ \begin{matrix}1 , & if not filterered by NMS , \\ 0 , & otherwise .\end{matrix}$$

### Neural Exposure Selection

Next, we provide further description on how we predict exposures for the separate HDR sub-frames. Specifically, we design an exposure selection network to determine the exposure value of each of the LDR captures for the next time step. Let eₜ be the exposure value produced by the network for time step t and eₜ^{(j)} the exposure value for time step t for capture j ∈ {1, . . . , n}. Then eₜ^{(j)} is computed as,

$${e}_{t}^{( j )} = {e}_{t} \cdot {δ}^{j - \frac{n + 1}{2}} ,$$

Where δ is an hyperparameter. In our experiments we choose δ=16.

### Additional Evaluations

In this section, we report additional qualitative and quantitative evaluations and additional ablation experiments.

### Additional Quantitative Evaluation

Next, we report additional object detection results for a separate unseen dataset in Table 1. This additional dataset is composed of challenging scenes of entrances and exits of tunnels. This dataset has been collected over three days of test driving in a large European city. The dataset has been subsampled to 1 Hz and challenging HDR scenarios with entrances and exits of tunnels have been manually selected, resulting in 418 test scenarios.

The results reported in Table 1A below show that our method Local Cross Attention Fusion (last row) performs best overall in terms of mAP. It also performs best for 5 out of 6 of the considered object classes. Interestingly, the method Local Cross Attention Fusion performs better than the method Deep HDR on this data set of exits and entrances of tunnels, although Deep HDR was the best performing method on the Tunnel subset in the above description (see results reported in column 5 of Table 2 above). The discrepancy is explained by the fact that the Tunnel subset not only contains entrances and exits of tunnels, but mainly inner sections of tunnels.

TABLE 1A
HDR object detection evaluation for different neural exposure fusion strategies
compared to conventional HDR imaging and object detection pipelines for
an additional dataset of scenes of entrances and exits of tunnels.

| | Classes | | | | | | |
|---|---|---|---|---|---|---|---|
| | | Bus | | | | | |
| | | & | Car | | Traffic | Traffic | |
| Methods | Bike | Truck | & Van | Person | Light | Sign | mAP |
| LDR Gradient AE [43] | 5.8 | 6.7 | 28.5 | 14.6 | 9.3 | 13.4 | 13.1 |
| LDR Average AE [1] | 7.3 | 9.3 | 34.1 | 19.2 | 14.0 | 23.2 | 17.9 |
| Onzon et al. [34] | 12.4 | 22.7 | 74.7 | 40.6 | 25.4 | 40.0 | 36.0 |
| (LDR) | | | | | | | |
| HDR I | 10.7 | 16.3 | 63.1 | 24.2 | 19.3 | 28.8 | 27.0 |
| HDR II | 11.5 | 24.5 | 79.2 | 44.2 | 25.9 | 39.4 | 37.5 |
| Deep HDR [19] | 12.8 | 23.2 | 79.1 | 39.8 | 25.4 | 37.0 | 36.2 |
| Early Fusion (ours) | 13.6 | 26.9 | 79.6 | 43.6 | 26.5 | 41.5 | 38.6 |
| Late Fusion (ours) | 11.8 | 21.9 | 81.1 | 43.1 | 25.6 | 40.7 | 37.4 |
| Local Cross Attention | 14.0 | 27.1 | 80.2 | 45.6 | 27.0 | 42.0 | 39.3 |
| (ours) | | | | | | | |

TABLE 2A
HDR object detection performances for additional exposure fusion
strategies evaluated on the test set used as described above. The
results reported here complement those reported in Table 2 above.

| | | Classes | | | | | |
|---|---|---|---|---|---|---|---|
| | | Bus | | | | | |
| | | & | Car | | Traffic | Traffic | |
| Methods | Bike | Truck | & Van | Person | Light | Sign | mAP |
| Late Fusion | 27.5 | 14.2 | 73.8 | 47.2 | 42.8 | 52.3 | 43.0 |
| Standard | | | | | | | |
| Loss | | | | | | | |
| Late Fusion | 26.5 | 16.1 | 74.4 | 48.4 | 42.9 | 54.7 | 44.0 |
| Keep Best | | | | | | | |
| Loss | | | | | | | |
| Late Fusion | 28.1 | 16.5 | 74.3 | 46.4 | 44.3 | 55.9 | 44.3 |
| NMS Loss | | | | | | | |
| Local Cross | 28.2 | 15.7 | 74.7 | 47.7 | 44.9 | 54.5 | 44.3 |
| Attention | | | | | | | |
| RPN | | | | | | | |

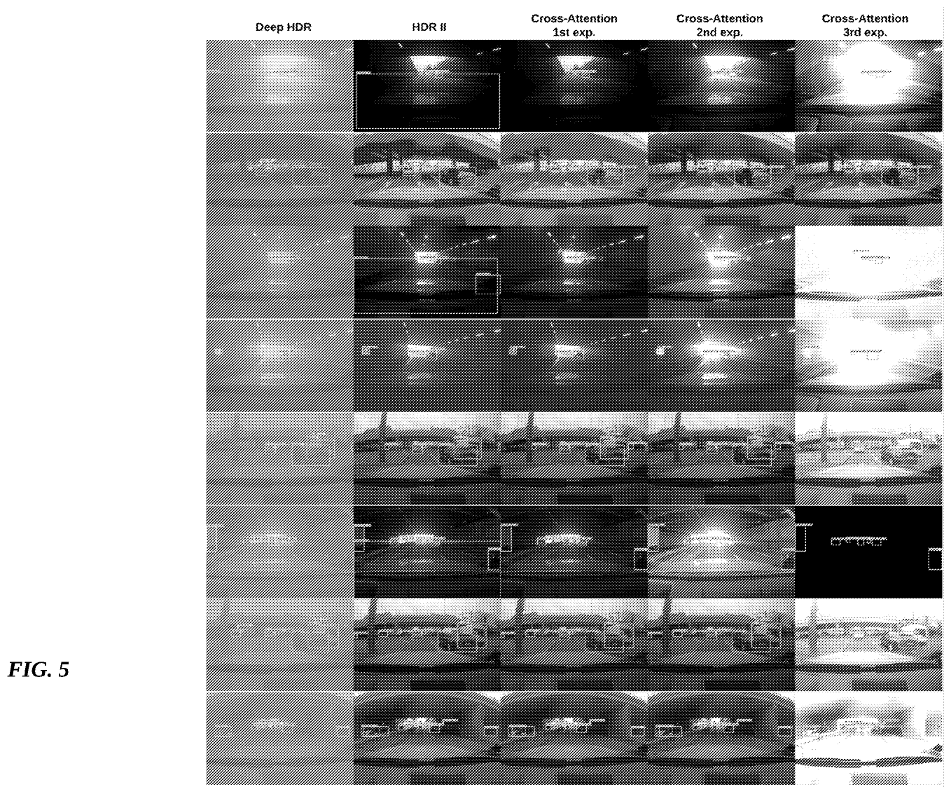

FIG. 5 shows a qualitative comparison of the proposed Local Cross-Attention Fusion with the baseline methods HDR II and Deep HDR on challenging scenes. Examples from the additional dataset of entrances and exits of tunnels, see supplemental text.

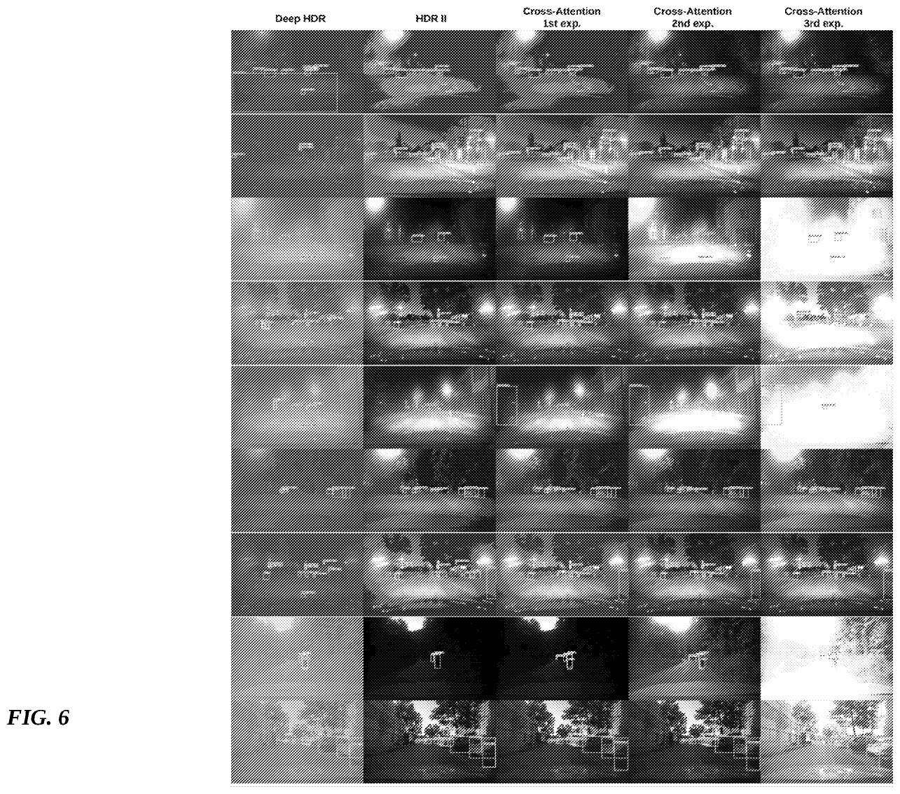

FIG. 6 shows a qualitative comparison of the proposed Local Cross-Attention Fusion with the baseline methods HDR II and Deep HDR on challenging scenes. Our neural fusion module recovers features from separate exposure streams, where the image region is well exposed to make its decision. Examples from the night and sun illumination conditions subset.

### Additional Ablation Experiments

As an additional ablation experiment, we train and test networks with alternative fusion strategies as described in Section 3 on the same training set and test set as described above. We report the results in Table 2A.

We note that the method named “Late Fusion Standard Loss” in this table corresponds with the method named “Late Fusion” in Table 2A above. Results are repeated here to better compare with the two other late fusion strategies where the training loss has been modified according to Section 3.2. We can see that these modifications are effective at improving the overall mAP by 1% and 1.3%. Moreover, the results reported in Table 2A show that these enhanced training losses also allow to improve the AP for most of the considered object classes. The last row of Table 2A reports the results for the method Local Cross Attention RPN Fusion. We can see that they are on par with or slightly better than the method Local Cross Attention Fusion (see last row of Table 2 above). This finding demonstrates that the use of our local cross attention module can prove effective across architectural variants.

### Additional Qualitative Results

FIGS. 5 and 6 provide further qualitative results. For each of them, there is at least one object for one of the competing methods (HDR II and Deep HDR) that is missed compared to the proposed method (Local Cross Attention Fusion), or that has a false positive. Sometimes the missed objects are small, like for example a traffic sign in the images of the last row of FIG. 6 or a person in the images of the second to last row of FIG. 6. The highest margins in improvement, not surprisingly, are achieved in scenes with large dynamic ranges, where conventional HDR pipelines fail to maintain details in the task-relevant image regions. Our approach differs from existing work as we combine learned exposure control using the downstream task and exposure fusion in feature instead of image space.

HDR imaging pipelines (e.g., HDR II and Deep HDR) are fusing the information of the different exposures in image space. For a large range of luminances in a given frame this can lead to under or overexposed regions. Moreover, the HDR imaging pipelines have to compress the dynamic range which inevitably entails a loss contrast in at least some parts of the image. These effects combine together and result in sub-optimal local detection performances.

The proposed learned fusion approach avoids losing details during image fusion by moving it in feature space. Our approach outperforms single exposure systems in two ways: 1) Details that are not visible in one stream can be recovered by relying on features of those streams, which expose the observed image region better. 2) Streams can collaborate by fusing features and therefore achieve higher performances than each of them in isolation, which could be interpreted as a natural form of test time augmentations.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment, or electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A method of detecting objects from camera-produced images comprising:
generating multiple raw exposure-specific images for a scene;
performing for the multiple raw exposure-specific images respective processes of image enhancement to produce respective processed exposure-specific images;
extracting from the processed exposure-specific images respective sets of exposure-specific features collectively constituting a superset of features;
identifying, using the respective sets of exposure-specific features, exposure-specific sets of candidate objects; and
fusing the exposure-specific sets of candidate objects to form a fused set of candidate objects.

2. The method of claim 1, wherein the respective processes of image enhancement include one or more of contrast stretching, demosaicing, resizing, a power transform, color correction, threshold unsharp mask filtering, affine transform, or learned gamma correction.

3. The method of claim 1, wherein the respective processes of image enhancement include:
applying a first color space transform to Y, Cb, Cr color space;
executing a denoising filter in the Y, Cb, Cr color space; and
applying a second color space transform to RGB color space.

4. The method of claim 1, wherein extracting the respective sets of exposure-specific features includes employing a ResNet neural network to generate the respective sets of exposure-specific features.

5. The method of claim 1, wherein extracting the respective sets of exposure-specific features includes encoding a presence of wheels, headlights, glass texture, or metal texture among the respective sets of exposure-specific features.

6. The method of claim 1, wherein identifying the exposure-specific sets of candidate objects includes computing respective bounding boxes for the exposure-specific set of candidate objects.

7. The method of claim 1, wherein fusing the exposure-specific sets of candidate objects includes:
combining the exposure-specific sets of candidate objects; and
removing a subset of candidate objects by non maximal suppression (NMS).

8. The method of claim 1, wherein fusing the exposure-specific sets of candidate objects includes:
merging the exposure-specific sets of candidate objects into respective ground truth objects using a keep best loss algorithm.

9. The method of claim 1, wherein generating multiple raw exposure-specific images includes employing an exposure selection network to determine an exposure value for an exposure t based on an exposure value for an exposure t−1.

10. A method of detecting objects from camera-produced images comprising:
generating multiple raw exposure-specific images for a scene;
deriving for each raw exposure-specific image a respective multi-level regional illumination distribution for use in computing respective exposure settings;
performing for the multiple raw exposure-specific images respective processes of image enhancement to produce respective processed exposure-specific images;
extracting from the processed exposure-specific images respective sets of exposure-specific features collectively constituting a superset of features;
detecting a set of candidate objects using the superset of features; and
pruning the set of candidate objects to produce a set of objects within the scene.

11. The method of claim 10, wherein the respective processes of image enhancement include one or more of contrast stretching, demosaicing, resizing, a power transform, color correction, threshold unsharp mask filtering, affine transform, or learned gamma correction.

12. The method of claim 10, wherein the respective processes of image enhancement include:
applying a first color space transform to Y, Cb, Cr color space;
executing a denoising filter in the Y, Cb, Cr color space; and
applying a second color space transform to RGB color space.

13. The method of claim 10, wherein extracting the respective sets of exposure-specific features includes employing a ResNet neural network to generate the respective sets of exposure-specific features.

14. The method of claim 10, wherein extracting the respective sets of exposure-specific features includes encoding a presence of wheels, headlights, glass texture, or metal texture within the superset of features.

15. The method of claim 10, wherein detecting the sets of candidate objects includes computing respective bounding boxes for the superset of features.

16. The method of claim 10, wherein pruning the sets of candidate objects includes removing a subset of candidate objects by non maximal suppression (NMS).

17. The method of claim 10, wherein pruning the sets of candidate objects includes merging the exposure-specific sets of candidate objects into respective ground truth objects using a keep best loss algorithm.

18. The method of claim 10, wherein pruning the sets of candidate objects includes employing a late fusion standard loss algorithm.

19. The method of claim 10, wherein generating multiple raw exposure-specific images includes employing an exposure selection network to determine an exposure value for an exposure t based on an exposure value for an exposure t−1.

20. The method of claim 10, wherein extracting respective sets of exposure-specific features comprises:
employing a region proposal network (RPN) to generate exposure-specific sets of features from the processed exposure-specific images;
pooling the exposure-specific sets of features; and
cropping a region of interest (RoI) to generate the superset of features.
